(19) United States
(12) Patent Application Publication
(10) Pub. No.: US 2005/0058292 A1
(43) Pub. Date: Mar. 17, 2005

(54) Secure two-way RFID communications

(75) Inventors: Christopher J. Diorio, Shoreline, WA (US); Aanand Esterberg, Seattle, WA (US); Todd E. Humes, Shoreline, WA (US)

Correspondence Address: David B. Ritchie;Thelen Reid & Priest LLP, P. O. Box 640640, San Jose, CA, 95164-0640, US

(73) Assignee: Impinj, Inc., a Delaware Corporation

(21) Appl. No.: 10/660,829

(22) Filed: Sep. 11, 2003

(51) Int. Cl. H04K 1/00

(52) U.S. Cl. 380/270

(57) ABSTRACT

Methods and apparatus for providing secure two-way (reader-to-tag and tag-to-reader) RFID communications. According to one aspect of the invention, a tag receives a noise-encrypted RF carrier signal from a reader and backscatter modulates it with tag information. Eavesdroppers cannot extract the tag information from the backscattered signal because it is masked by the noise encryption. According to another aspect of the invention, establishing a secure two-way RFID communication link includes a reader modulating a carrier signal with a noise encryption signal and broadcasting the noise-encrypted carrier to a singulated tag. The tag backscatter modulates the noise-encrypted carrier with a first portion of a key and/or a one-time pad pseudorandom number. If a key is used, upon receiving the backscattered signal the reader verifies that the tag is authentic, and, if verified as authentic, transmits a second portion of the key, possibly encrypted by a function depending on the one-time pad pseudorandom number, to the tag.

### FIELD OF THE INVENTION

The present invention relates generally to Radio Frequency IDentification (RFID). More particularly, the present invention relates to secure two-way RFID communications.

### BACKGROUND OF THE INVENTION

Radio Frequency IDentification (RFID) systems are used for identifying and tracking items, inventory control, supply chain management, anti-theft of merchandise in stores, and other applications. As shown in FIG. 1, a typical RFID system 10 consists of a plurality of transponders (referred to in the art as “tags”) 100-0, 100-1, . . . , 100-N and one or more transceivers (referred to in the art as a “readers”) 102. A reader 102 includes an antenna 104, which allows it to interrogate one or more of the tags 100-0, 100-1, . . . , 100-N over a wireless link 106. The tags 100-0, 100-1, . . . , 100-N also have their own respective antennas 108-0, 108-1, . . . , 108-N, which allow them to transmit tag information back to the reader 102 over reverse links 107-0, 107-1, . . . , 107-N. The reader 102 may then use this tag information as a look-up key into a back-end database 110, which stores product information, tracking logs, key management data, etc.

In order for the reader 102 to address any particular tag from the population of tags 100-0, 100-1, . . . , 100-N, a process known as “singulation” is commonly used. To singulate a tag from the population of tags 100-0, 100-1, . . . , 100-N, the reader 102 polls the tags 100-0, 100-1, . . . , 100-N for their ID numbers. Because multiple tag responses may interfere with one another, anti-collision algorithms are typically employed in the singulation process. Anti-collision algorithms are either probabilistic or deterministic. One well-known probabilistic anti-collision algorithm is the Aloha technique, whereby tags 100-0, 100-1, . . . , 100-N respond to a polling signal from the reader 102 at random intervals. If a collision occurs, the tags responsible for the collision wait for another, usually longer, time interval before responding again. A known deterministic anti-collision algorithm is the so-called “binary tree-walking” algorithm. According to this approach, the reader 102 initially polls the tags 100-0, 100-1, . . . , 100-N for the first bit of the tags' respective ID numbers. Based on the bit values received, the reader 102 then limits the number of tags which are to send subsequent bits of their ID numbers. This process is repeated until the ID of a single tag has been singulated.

A tag is usually embodied as a semiconductor microchip having a small amount of memory for storing the tag's ID number and, in some applications, information concerning the item to which the tag is associated. Further, tags are either “passive” or “active”, depending on how they are powered. An active tag contains its own on-board power source, i.e. a battery, which the tag uses to process received signals and to transmit tag information back to a reader. A passive tag does not have its own on-board power source. Rather, it derives the power it needs by extracting energy from the RF carrier signals broadcast by the reader. The passive tag transmits information to the reader using a process known as modulated backscattering, a process which is described in more detail below. Because passive tags do not have their own power sources, and rely on backscattering, they cannot be read from great distances. Nevertheless, they have, in many applications, become more popular than active tags since they are less expensive to manufacture, maintain, and operate.

In a conventional passive-tag-based RFID system, a tag derives its power from a CW signal sent from a reader over a forward link 204. As shown in FIG. 2, a tag 200 also modulates the CW signal using modulated backscattering, a process by which the antenna matching network impedance is varied depending on the information being provided by the tag. For digital information, the antenna terminal may be simply switched by the tag's modulating signal, from being an absorber of RF radiation to being a reflector of RF radiation. In this manner the tag's information is encoded on the CW signal and backscattered back to the reader 202 over a reverse (or “backscatter” link) 206.

Whereas RFID systems provide a useful system for identifying and tracking objects, such systems are subject to a number of privacy and security risks. These security risks can arise during polling, singulation, and following singulation when a reader is communicating one-on-one with a particular tag. Without adequate access control, unauthorized (i.e. “rogue”) readers may be able to interrogate tags or intercept information, which would otherwise remain secret. (FIG. 2 shows, for example, an eavesdropper 208 intercepting a backscattered signal from the tag 200.) Further, rogue (or “spoofed”) tags, which have been made or modified to appear as authentic tags, may be able to gather information from legitimate readers.

In addition to the security concerns just described, RFID systems without proper security and privacy measures in place undesirably allow unauthorized “location tracking”. Unauthorized location tracking allows one or more readers to track RFID-labeled items (e.g. clothing worn by an individual or items an individual may be carrying such as tagged smart cards, credit cards, banknotes, etc.) Consequently, without proper access control or prevention measures in place, the privacy normally taken for granted concerning an individual's movement, social interactions and financial dealings can be compromised by RFID systems.

Various proposals for addressing the security and privacy risks associated with RFID systems have been proposed. One technique that has been proposed to avoid unauthorized access to readers and tags of an RFID system is “symmetric encryption”. According to this technique, special encryption and decryption hardware is built into both the readers and the tags of the RFID system. A block diagram of a symmetric encryption RFID system is shown in FIG. 3. A drawback of the symmetric encryption approach, however, is that a large number of logic gates (e.g. between 20,000 and 30,000) is required to implement the encryption and decryption hardware. This increases the size and complexity of the microchip embodying the tag. Consequently, symmetric encryption is not a technique that allows the manufacture of small and inexpensive tags. For at least this reason, therefore, symmetric encryption is not a favorable solution to RFID.

Another technique that has been applied to avoid the security and privacy concerns described above is a technique known as “public-key” encryption. Use of public-key encryption permits a tag to transmit encrypted information, together with a public key known by both the reader and the tag, to the reader. The reader, having a private key known only to it, is then able to decrypt the information communicated by the tag. Unfortunately, similar to the symmetric encryption approach, public-key encryption requires a large number of logic gates (e.g. >30,000 logic gates) to implement the encryption hardware. Accordingly, for reasons similar to that associated with use of symmetric encryption, public-key encryption is not a simple and cost-effective approach to RFID.

Whereas many existing and proposed RFID systems prove to be prohibitively expensive for widespread deployment, others make assumptions that, if built into an RFID system, do not sufficiently respect the security and privacy concerns discussed above. An example of such a security and privacy compromised RFID system is described in “Security and Privacy Aspects of Low-Cost Radio Frequency Identification Systems,” by Stephen A. Weis, Sanjay E. Sarma, Ronald L. Rivest and Daniel W. Engels, First International Conference on Security in Pervasive Computing (Mar. 12-14, 2003). The RFID systems proposed in that paper assume that it is only possible for an eavesdropper to monitor the forward link (i.e. signals sent from the reader to the tags). In other words, it is assumed that the power in the link from the tag to the reader (i.e. the backscatter link) is so weak, and/or that any possible eavesdropper is at such a large distance away from the tag, that an eavesdropper could not possibly intercept information from it. It also makes the assumption that security can be enhanced, simply by reducing the power in the backscatter link. For a number of reasons described below, however, an RFID system designed using these assumptions would have reduced security and privacy effectiveness.

First, because tags of a passive-tag RFID system extract their power from the carrier on the forward link (i.e. reader-to-tag link), the power of the signal in the forward link must be large enough so that sufficient power is available for the tag to operate. This means that the power in the backscatter link can be quite large. Accordingly, the assumption that the power in the backscatter link is so weak that an eavesdropper cannot intercept it is not necessarily a fair assumption. Second, even if it is assumed that an eavesdropper is a large distance away from the tag, this large distance may, in many circumstances, be overcome simply by using a larger eavesdropper antenna. Finally, even if power in the backscatter link could be reduced by lowering the power in the forward link to enhance security, not only would the range of the RFID system be limited and consequently have diminished utility, such an approach could also be defeated, again simply by using a larger eavesdropper antenna.

### SUMMARY OF THE INVENTION

Methods and apparatuses for providing secure two-way (reader-to-tag and tag-to-reader) RFID communications are disclosed. According to one aspect of the invention, an RF carrier signal from a reader is modulated (e.g. using amplitude modulation, or frequency and/or phase modulation) to noise encrypt the RF carrier signal. In this context and in the description of other embodiments of the invention, this noise encryption is meant to include any signal(s) not known to an unintended or unauthorized recipient (i.e. unintended or unauthorized reader, tag, or eavesdropper). A tag receives the noise-encrypted RF carrier signal and backscatter modulates it with tag information. The tag information may comprise the tag's ID number or other information associated with the item to which the tag is attached. Eavesdroppers cannot extract the tag information from the backscattered signal because it is masked by the noise encryption.

According to another aspect of the invention, methods and apparatus for establishing a secure two-way RFID communication link are disclosed. According to this aspect of the invention, a reader of the RFID system modulates a carrier signal with a noise encryption signal and broadcasts it to a singulated tag. The noise encryption signal may comprise, for example, an amplitude modulation signal and/or a phase or a frequency modulation signal. The singulated tag backscatter modulates the noise-encrypted carrier signal with a first portion of a key and/or a one-time pad pseudorandom number. If a key is used, upon receiving the backscattered signal the reader verifies that the tag is authentic, and, if verified as authentic, transmits a second portion of the key, possibly encrypted by a function depending on the one-time pad pseudorandom number, to the singulated tag.

Other aspects of the inventions are described and claimed below, and a further understanding of the nature and advantages of the inventions may be realized by reference to the remaining portions of the specification and the attached drawings.

### BRIEF DESCRIPTION OF THE DRAWINGS

FIG. 1 shows a typical prior art RFID system.

FIG. 2 shows a prior art passive-tag RFID system, illustrating the forward link with its continuous wave (CW) signal, the reverse (or “backscatter” link), and an eavesdropper intercepting a backscattered signal.

FIG. 3 shows a prior art symmetric encryption RFID system, highlighting the fact that both the tag and reader include substantial hardware components.

FIG. 4 shows an RFID system, according to an embodiment of the present invention.

FIG. 5 shows the backscattered frequency domain baseband equivalent spectrum of a backscattered signal, in which no amplitude or phase modulation has been applied to the reader carrier signal, as might be found in the prior art.

FIG. 6 shows the backscattered frequency domain baseband equivalent spectrum of a noise modulated (i.e. A(t)≠1 and θ(t)≠0) backscattered signal, according to an embodiment of the present invention.

FIG. 7 shows baseband waveforms of a backscattered signal in which the noise attributable to A(t) and θ(t) have been properly removed, according to embodiments of the present invention.

FIG. 8 shows baseband waveforms of backscattered signals where the noise attributable to A(t) and θ(t) have not been properly removed, as might be the case of an eavesdropper lacking knowledge of the noise sequences responsible for A(t) and θ(t).

FIG. 9 shows an RFID system, which applies AM noise to the reader carrier signal, according to an embodiment of the present invention.

FIG. 10 shows an RFID system, which applies FM/PM to the reader carrier, according to an embodiment of the present invention.

FIG. 11 shows a timing diagram illustrating a method of establishing a secure two-way communication link between a reader and a tag of a population of tags, according to an embodiment of the present invention.

FIG. 12 shows a timing diagram illustrating a method of establishing a secure two-way communication link between a reader and a tag of a population of tags, including applying a password lock to a singulated tag, according to an embodiment of the present invention.

FIG. 13 shows how, in establishing a secure two-way communication link according to embodiments of the present invention, a rogue reader is prevented access to information backscattered by a tag.

FIG. 14 shows how, in establishing a secure two-way communication link according to embodiments of the present invention, a rogue tag is prevented from communicating with a legitimate reader.

FIG. 15 shows an analog implementation of an RFID system, according to an embodiment of the present invention, in which both AM and FM/PM are used to modulate an RF carrier signal.

FIG. 16 shows an analog implementation of an RFID system, in which AM is used to modulate the carrier signal, according to an embodiment of the present invention.

FIG. 17 shows an analog implementation of an RFID system, in which FM/PM is used to modulate the carrier signal, according to an embodiment of the present invention.

FIG. 18 shows a combined analog and digital implementation of an RFID system, in which both AM and FM/PM are used to modulate an RF carrier signal, according to an embodiment of the present invention.

FIG. 19 shows a combined analog and digital implementation of an RFID system, in which AM is used to modulate an RF carrier signal, according to an embodiment of the present invention.

FIG. 20 shows a combined analog and digital implementation of an RFID system, in which FM/PM is used to modulate an RF carrier signal, according to an embodiment of the present invention.

FIG. 21 shows a digital implementation of an RFID system, according to an embodiment of the present invention.

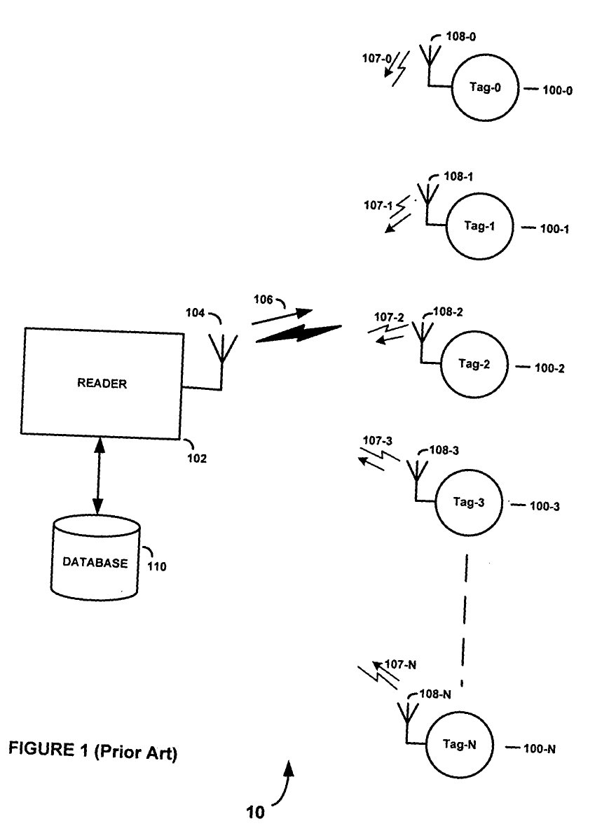

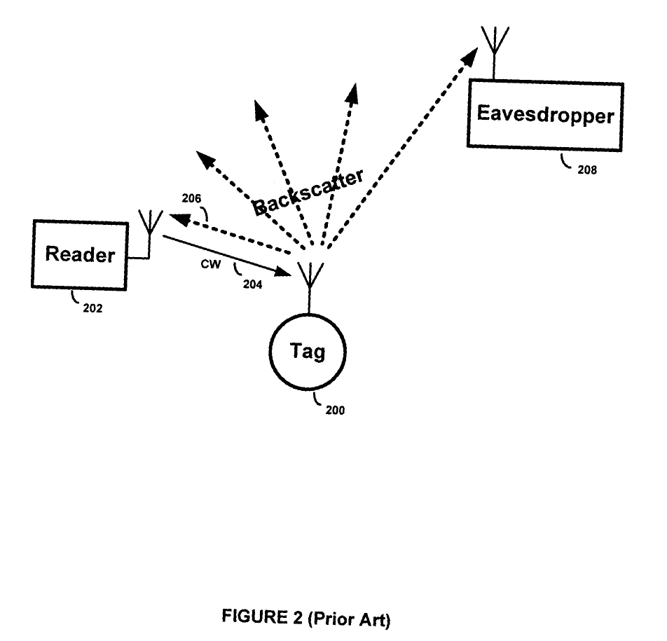

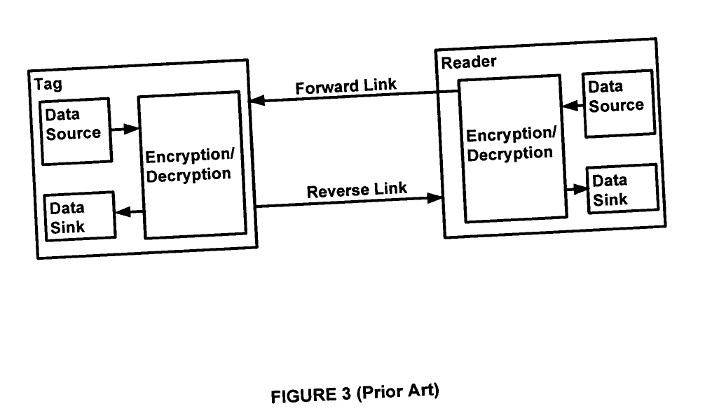

### DETAILED DESCRIPTION

Embodiments of the present invention are described herein in the context of methods and apparatuses relating to secure two-way RFID communications. Those of ordinary skill in the art will realize that the following detailed description of the present invention is illustrative only and is not intended to be in any way limiting. Other embodiments of the present invention will readily suggest themselves to such skilled persons having the benefit of this disclosure.

Reference will now be made in detail to implementations of the present invention as illustrated in the accompanying drawings. The same reference indicators will be used throughout the drawings and the following detailed description to refer to the same or similar parts.

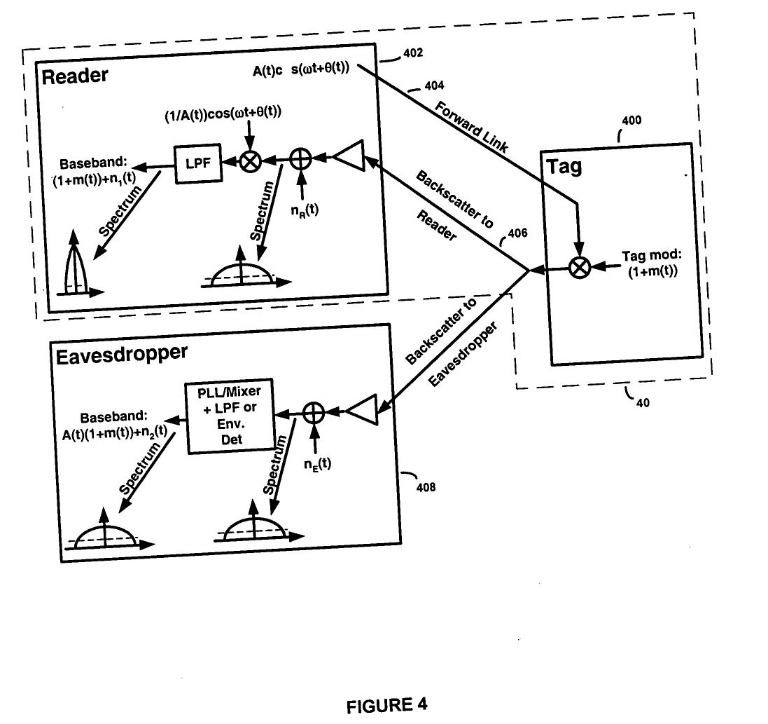

Referring first to FIG. 4, there is shown an RFID system 40, according to an embodiment of the present invention. RFID system 40 comprises a reader 402 and one or more tags 400. Although not shown in FIG. 4 or other drawings in the disclosure, those skilled in the art will readily understand that both the reader 402 and tags 400 have antennas that permit the reader 402 to communicate with the tags 400 over an RF forward link 404 and the tags 400 to receive and backscatter RF signals back to the reader 402 over an RF backscatter link 406.

To communicate with a tag 400, the reader 402 broadcasts an RF signal to the tag 400. The RF signal is a continuous wave carrier signal, cos(ωt), modulated by an amplitude modulation signal, A(t), and by a phase modulation signal, θ(t). For purposes of this disclosure, θ(t) represents either or both frequency modulation and phase modulation. Accordingly, at various instances throughout the disclosure, the notation “FM/PM” will be used to indicate that either or both phase modulation and frequency modulation may be used to establish θ(t). The amplitude and phase modulated carrier signal is shown in FIG. 4 as A(t)cos(ωt+θ(t)). The amplitude modulation, A(t), and phase modulation, θ(t), are only known by the reader 402. Accordingly, together they serve as an encryption key. Note that if no encryption were present in the forward link signal, A(t) would equal unity and θ(t) would equal zero.

Upon receipt of the A(t)cos(ωt+θ(t)) signal by the tag 400, the tag 400 extracts power from the RF energy in the signal. The tag 400 also backscatter modulates A(t)cos(ωt+θ(t)) with a tag modulation signal (1+m(t)). The tag modulation signal (1+m(t)) contains identification information associated with tag 400, e.g., the tag's ID and/or information concerning the item to which the tag is associated. This information becomes masked by the amplitude and phase modulation noise provided by the A(t)cos(ωt+θ(t)) signal during backscattering, thereby providing an encrypted backscattered signal.

The reader 402 receives the backscatter modulated signal and amplifies it, for example by way of an automatic gain control (AGC) amplifier, sufficiently enough so that the reader receiver hardware is able to operate in the proper range. n_{R}(t) in the drawing represents thermal noise that is unavoidably added to the received signal. Since the reader knows A(t) and θ(t), their inverses can be mixed with the received signal to remove the encryption caused by A(t) and θ(t). The resulting signal is then low-pass-filtered to remove the double frequency products generated by the mixer and other high frequency noise. The result at the output of the LPF is the desired baseband signal, i.e. (1+m(t)), plus some unavoidable noise component, n_{J}(t).

Also shown in FIG. 4 is an eavesdropper 408. The eavesdropper 408 is not part of the system 40, but is shown in FIG. 4 to illustrate how it might attempt to intercept transmission of backscattered signals in the backscatter link 406. If the eavesdropper 408 is somehow in range to receive the backscattered signal, it would have to first perform some AGC action to amplify the received signal, similar to what the reader 402 does. The frequency spectrum of the received signal would be similar to what the reader 402 receives. However, unlike the reader 402, the eavesdropper 408 has no knowledge as to what the amplitude modulation signal, A(t), looks like or what θ(t) is. Consequently, the eavesdropper 408 can only mix with a local oscillator that does not have any information relating to the inverses of A(t) or θ(t).

The eavesdropper 408 might contain a phase locked loop (PLL) and a mixer, followed by an LPF, to produce a baseband signal. Alternatively, an envelope detector might be used, if the FM/PM in the received signal cannot be tracked using a PLL. Use of an envelope detector would introduce additional degradations to the signal (i.e. in addition to the noise masking effect caused by A(t) and θ(t)), which would further reduce the likelihood that the eavesdropper 408 could ever succeed at actually extracting tag information from the backscattered signal. Assuming that either a PLL/Mixer and LPF or an envelope detector are used, the LPF would also have to have a much higher cutoff frequency than the LPF used by the reader 408. The reason for this is that, because the eavesdropper 408 cannot remove the AM and possibly the FM/PM components at the front-end, the tag information signal (1+m(t)) remains spread over a broader frequency range than the “de-spread” signal produced by the reader 402. Consequently, the eavesdropper 408 would require the use of an LPF having a much greater cutoff frequency than that of the LPF used by the reader 402. The required use of a broader band LPF presents additional problems to the eavesdropper 408, since additional noise not filtered by the LPF, and introduced in the baseband signal, further decreases the likelihood that the eavesdropper 408 could ever determine the tag information signal (1+m(t)).

Even if the eavesdropper 408 was somehow successful at removing the FM/PM component, there would still remain the AM component, which masks the tag information signal (1+m(t)). At best, all the eavesdropper could ever obtain at baseband is the baseband signal, A(t)(1+m(t))+n₂(t), i.e. the product of two time varying functions and a noise component, n₂(t). The eavesdropper 408 does not have knowledge of A(t) or (1+m(t)) separately. Consequently, the backscattered signal cannot be decrypted by the eavesdropper 408, and the information in the tag information signal (1+m(t)) cannot be ascertained by the eavesdropper 408.

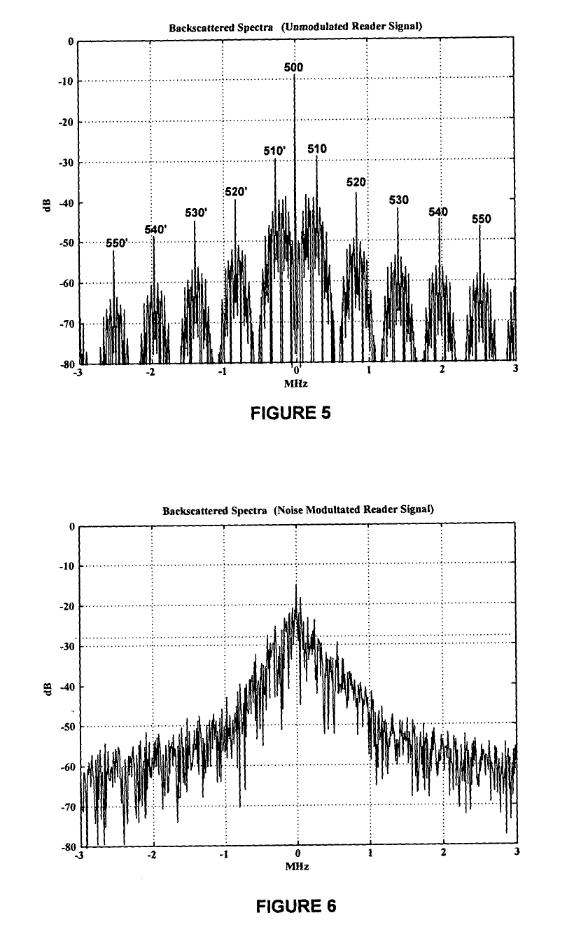

The noise masking effect caused by amplitude modulating and phase modulating the reader interrogation carrier signal can be seen by comparing FIG. 5 to FIG. 6. FIG. 5 shows the backscattered frequency domain baseband equivalent spectrum of a backscattered signal in which no amplitude or phase modulation has been applied to the reader carrier signal (i.e., where A(t)=1 and θ(t)=0). Distinct peaks (i.e. 500, 510, 520, . . . and 510′, 520′, 530′, . . . ) corresponding to bits of information in the tag modulation signal (1+m(t)), can be seen. This is an unfavorable situation, as it raises the possibility that the bits of information can be intercepted by a rogue reader. FIG. 6, by comparison, shows the backscattered frequency domain baseband equivalent spectrum of a noise modulated (i.e. A(t)≠1 and θ(t)≠0) backscattered signal, according to an embodiment of the present invention. As can be seen, the noise fills up the channel and masks (i.e. covers up) the spectral shape of the tag modulation signal (1+m(t)).

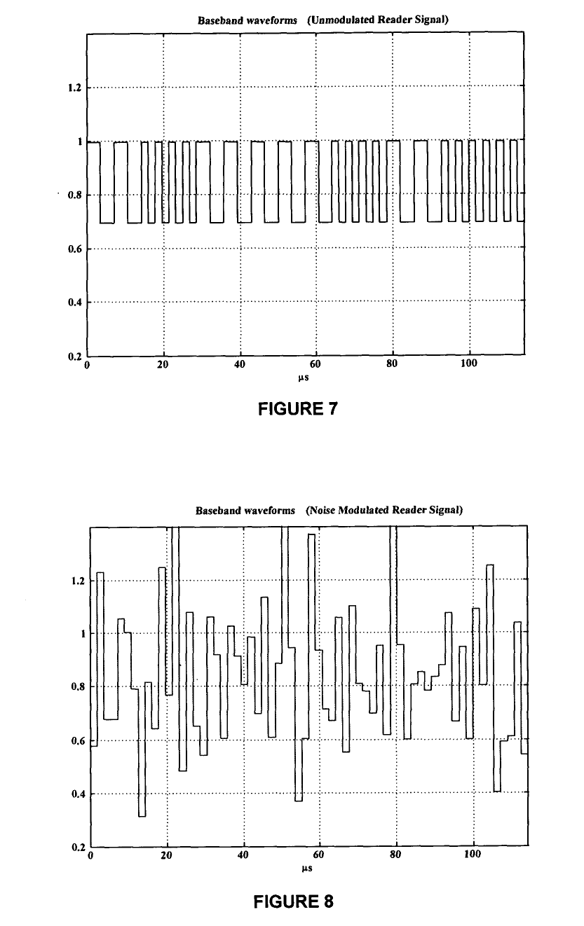

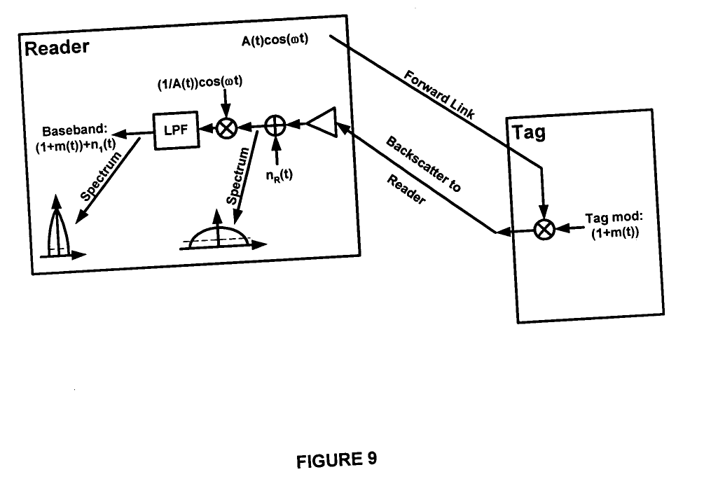

The noise masking effect can be further seen by comparing baseband waveforms of the reader 402 and eavesdropper 408 in the time domain. FIG. 7 shows baseband waveforms of backscattered signals in which the noise attributable to A(t) and θ(t) have been properly removed, according to embodiments of the present invention. Bits of logic value “1” or “0” are clearly discernable. By contrast, FIG. 8 shows baseband waveforms of backscattered signals where the noise attributable to A(t) and θ(t) have not been properly removed, as might be the case of an eavesdropper lacking knowledge of the noise sequences responsible for A(t) and θ(t). As can be seen from FIG. 8, the amplitude of the bits varies wildly and bit values cannot be accurately discerned. Consequently, from the eavesdropper's perspective it is difficult if not impossible to determine whether any given bit is a one or a zero. In the case of FIG. 7, however, the reader can and has inverted A(t) and θ(t) since it knows the noise sequences that produce A(t) and θ(t).

Whereas the RFID system shown in FIG. 4 modulates the reader carrier signal using both AM and FM/PM, alternative embodiments could use one or the other. Accordingly, FIG. 9 shows an RFID system, which applies AM to the reader carrier, according to an embodiment of the present invention. Because only the reader has knowledge of the characteristics of the AM applied, an eavesdropper cannot decrypt tag information backscattered from a tag.

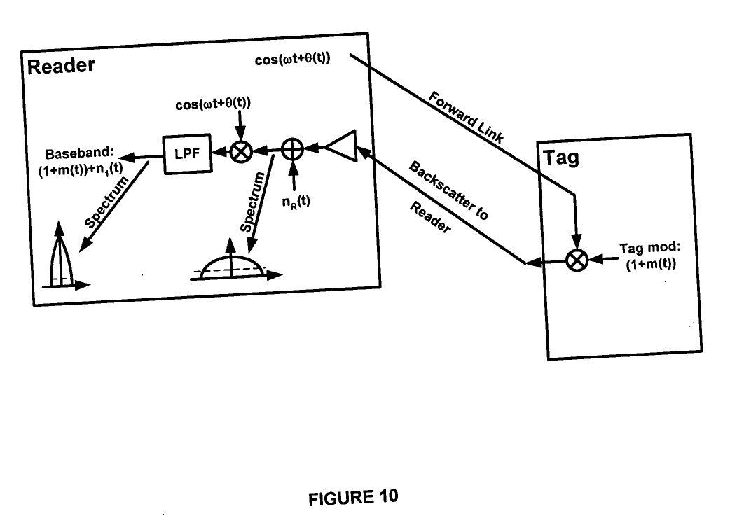

FIG. 10 shows an RFID system, which applies FM/PM to the reader carrier, according to an embodiment of the present invention. Because only the reader has knowledge of the characteristics of the FM/PM applied, an eavesdropper cannot decrypt tag information backscattered from a tag.

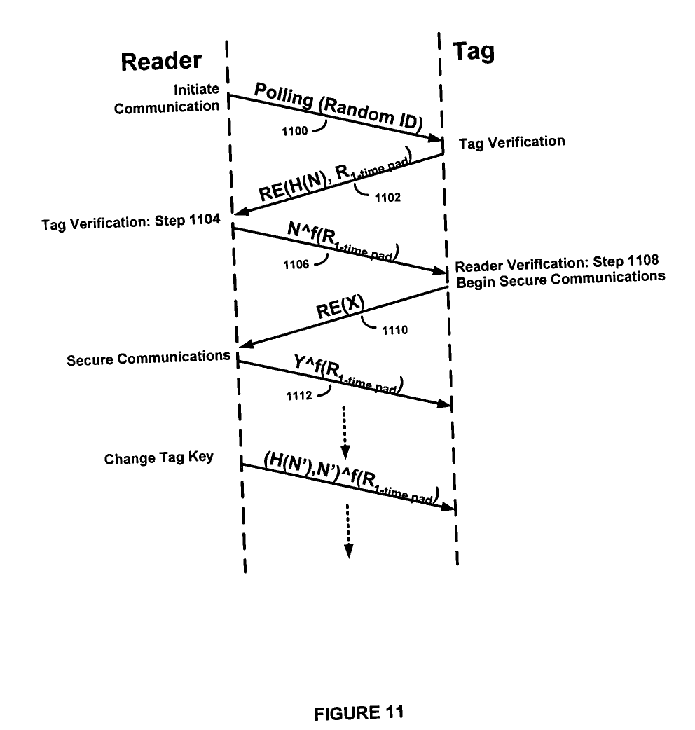

Referring now to FIG. 11, there is shown a timing diagram illustrating a method of establishing a secure two-way communication link between a reader and a tag of a population of tags, according to an embodiment of the present invention. According to this method, secure links are established both in the reader-to-tag direction and in the tag-to-reader direction. Because the method maintains two-way security during the entire time the secure two-way communication link is being established, rogue readers and rogue tags are prevented from intercepting and deciphering communications. Further aspects of the method, described in detail below, also prevent location tracking.

At step 1100 in the method shown in FIG. 11, a reader initiates communication by polling a population of tags, e.g. by broadcasting a polling signal having a random or pseudorandom ID. In response to the polling signal, the tags backscatter one or more bits. According to one embodiment, the backscattered bits from each tag are bits of pseudorandom numbers generated by a pseudorandom number (PN) generator on the tags. Using a tree-walking scheme, the reader responds, for example, by communicating that it only wishes to communicate with, for example, tags that transmitted bits of logic value “1”. Because the tags respond to each polling signal with one or more bits of a pseudorandom number, eventually a single tag is singulated. Whereas a binary tree-walking scheme has been described, those skilled in the art will readily understand that other singulation and anti-collision algorithms (probabilistic or deterministic) may be used to singulate the tag. Further, whereas singulating a tag has been described by use of a PN generator on the tag, singulation may be performed by simply using unique information stored on the tag (i.e. irrespective of whether a PN generator is on the tag).

Next, at step 1102, the singulated tag backscatters back to the reader a partial key, H(N), and a one-time pad pseudorandom number, R_{1-time pad}. The one-time pad, R_{1-time pad}, may have a value that is time independent or may have value that may be changed over time. Further, it may be generated by the tag or simply stored on (but not necessarily generated b) the tag. Whereas both the partial key, H(N), and one-time pad are used in step 1102, in alternative embodiments of the invention either of the partial key, H(N), or one-time pad, R_{1-time pad}, alone may be used. Noise encryption, as for example described above in relation to FIGS. 4-10, and denoted by “RE” in FIG. 11, is used to further encrypt the backscattered signal in this step 1102.

Upon receipt of the backscattered signal, at step 1104 the reader consults a secure back-end database to determine whether the value of H(N) sent from the tag is valid and, accordingly, whether the tag is authentic. If the reader determines that H(N) is a valid partial key, the method continues to step 1106. Otherwise, the reader discontinues communications with the tag, assuming that it is not authentic.

If the reader verifies that the tag is authentic, at step 1106 the reader transmits the other portion of the key, N, on the forward link to the tag. According to one embodiment, N is encrypted with a function that depends on a pseudorandom number, which may be, for example, the one-time pad, R_{1-time pad}, which was backscattered by the tag in step 1102. In FIG. 11, the encryption is shown as N\hat{ }f(R_{1-time pad}), the “\hat{ }” symbol indicating an exclusive OR (XOR) logic operation. Those skilled in the art will readily understand that an XOR operation is not required to form the encrypted key, and that other encryption schemes may be employed. The XOR operation is used in the described exemplary embodiment as it is computationally inexpensive.

Next, at step 1108 the tag verifies the authenticity of the reader, based on the value of the partial key, N, sent by the reader. Only a legitimate reader has access to the partial key N stored on the back-end database, and N will only be sent out if the tag had previously sent the correct first partial key, H(N). If the tag verifies that the reader is authentic after decrypting the forward link, the method continues at step 1110. Otherwise, the tag will not respond to any further interrogation by the apparent rogue reader.

If the tag verifies that the reader is authentic in step 1108, a secure two-way communication link is completed, and secure two-way communications can be started. This is indicated in step 1110 by the noised encrypted communication signal, RE(X) (tag-to-reader link), and in step 1112 by the encrypted communication signal, Y\hat{ }f(R_{1-time pad}) (reader-to-tag link) signal Y, which is encrypted by XOR'ing Y with a-function dependent on the one-time pad, R_{1-time pad}. Backscatter communications (i.e. RE(X)) may be noise-encrypted using the encryption techniques described above in relation to FIGS. 4-10. Noise encryption in the forward link, while shown to use an XOR operation and a function of the one-time pad, R_{1-time pad}, may alternatively use different encryption applying operations and other pseudorandom numbers besides R_{1-time pad}. For example, the one-time pad may be modified at times (e.g. upon a request by a legitimate reader) to prevent eavesdroppers from determining, through multiple transmissions, the one-time pad and, consequently, the message contents.

Because the reader has access to both portions of the key, i.e. to H(N) and N, it has the ability to change the key values as well. Accordingly, after some elapsed time, the reader can change one or both of the values of the partial keys, H(N) and N. To perform this key value changing operation, the reader transmits both portions of the modified tag key (denoted as N′ and H(N′)) in FIG. 11, and transmits them to the tag, which stores the new values in its on-board memory. Hence, upon subsequent interrogations of the tag, the tag will have to backscatter the updated partial key, H(N′), before the reader will authenticate the tag. Assuming that the tag does, in fact, respond with the proper tag partial key, H(N′), the reader responds with the other portion of the encrypted key (N′)\hat{ }f(R_{1-time pad}) to establish a new secure two way communication link. This option of modifying the key values is useful in that it provides further security against a rogue reader, since a rogue reader would not see the same H(N) every the tag is interrogated.

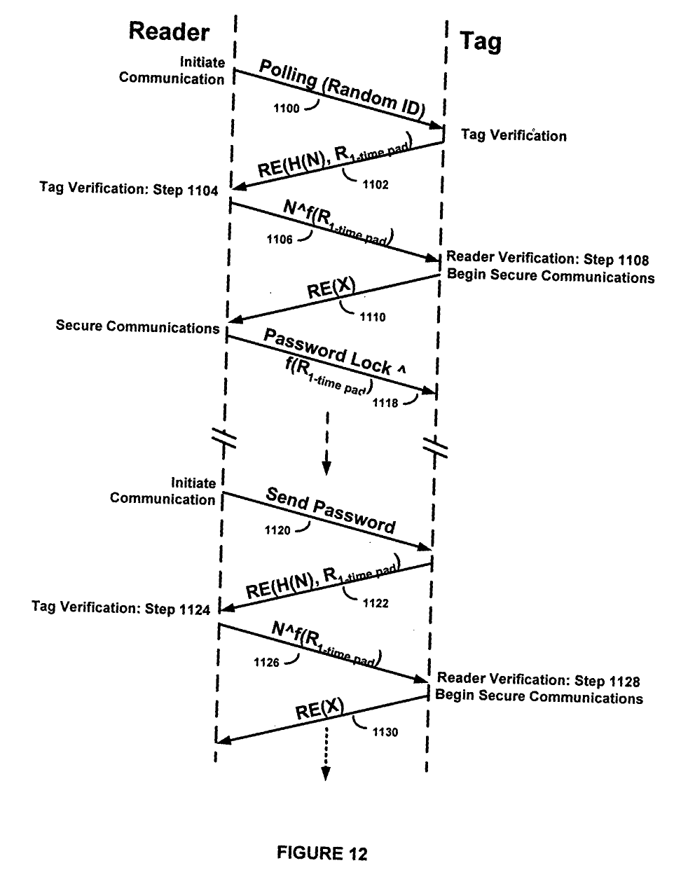

Referring now to FIG. 12, there is shown a timing diagram illustrating a method of establishing a secure two-way communication link between a reader and a tag of a population of tags, including applying a password lock to a singulated tag, according to an embodiment of the present invention. The password lock aspect of the invention provides security and privacy if, for example, a tag is taken out of range of a legitimate reader. In particular of using the password lock is beneficial in that once a tag is taken out of range of the reader (as happens, for example, after a customer purchases an item having a tag associated with it and leaves the store from which it is purchased), rogue readers are unable to location track the tag.

Steps 1100 through 1110 of the method in FIG. 12 relate to singulating a tag and establishing a secure two-way communication link. These steps are identical to or substantially similar to steps 1100 through 1110 in the method shown and described in relation to FIG. 11. Accordingly, the steps have been assigned the same reference numbers. Once the secure two-way communication link has been established in steps 1100 through 1110, at an appropriate time a reader issues a password lock to the singulated tag in step 1118. This password lock command, which includes a password, may be encrypted by an encryption function. In FIG. 12, this encryption is shown to be f(R_{1-time pad}) XOR'd with the Password Lock, i.e., Password Lock \hat{ } f(R_{1-time pad}). Those skilled in the art will understand that other encryption functions may be used and that other encryption operators other than the XOR operator may be used.

To initiate communication with a tag once the tag has been password locked, the tag must first receive the correct password. Step 1120 in FIG. 12 shows the reader sending the correct password to the tag. The tag responds, at step 1122 by backscattering a noise-encrypted partial key, H(N), and one-time pad, R_{1-time pad}, i.e., by backscattering RE(H(N), R_{1-time pad}), identical or similar to the step 1104 describe in relation to FIG. 11 above.

Upon receipt of the backscattered signal, at step 1124 the reader consults a secure back-end database to determine whether the value of H(N) sent is valid and, accordingly, whether the tag is authentic. If the reader determines that H(N) is a valid partial key, the method continues to step 1126. Otherwise, the reader discontinues communications with the tag, assuming that it is not authentic.

If the reader verifies that the tag is authentic, at step 1126 the reader transmits the other portion of the key, N, on the forward link to the tag. According to an embodiment of the invention, N is encrypted with a function that depends on a pseudorandom number, which may be, for example, the one-time pad, R_{1-time pad}, which was backscattered by the tag in step 1122. In FIG. 12, the encryption is shown as N\hat{ }f(R_{1-time pad}). Those skilled in the art will readily understand that the XOR operation is not the only operator that may be used to form the encrypted key, and that other encryption schemes may be employed.

Next, at step 1128 the tag verifies the authenticity of the reader, based on the value of the partial key, N, sent by the reader. Only a legitimate reader has access to the partial key N stored on the back-end database, and N will only be sent out if the tag had previously sent the correct first partial key, H(N), and one-time pad, R_{1-time pad}. If the tag verifies that the reader is authentic, the method continues at step 1130. Otherwise, the tag will not respond to any further interrogation by the apparent rogue reader.

If the tag verifies that the reader is authentic in step 1128, a secure two-way communication link is completed, and secure two-way communications can be started. This is indicated in step 1130 by the noised encrypted communication signal, RE(X) (tag-to-reader link).

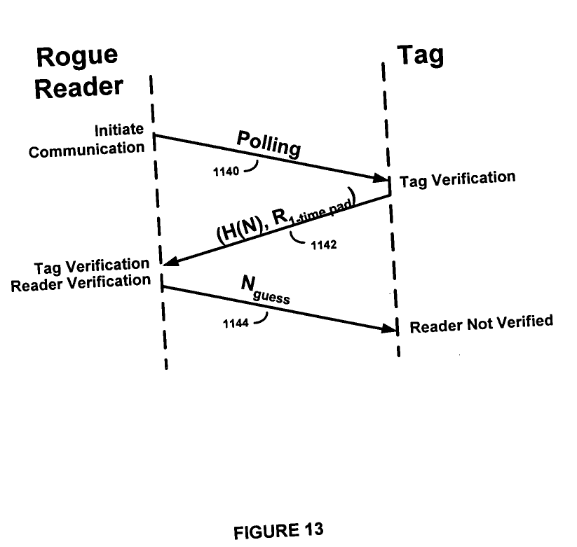

FIG. 13 shows how, in establishing a secure two-way communication link according to embodiments of the present invention, a rogue reader is prevented access to information backscattered by the tag. For a rogue reader to access information on the tag, it would have to initiate communication with the tag by polling and singulating the tag. This is shown as step 1140 in FIG. 13. If somehow the rogue reader succeeds at singulating the tag, at step 1142 the tag may respond by backscattering a partial key, H(N), and one-time pad, R_{1-time pad}. The backscattered signal including the partial key, H(N), and one-time pad, R_{1-time pad}, is shown in FIG. 13 as (H(N), R_{1-time pad}). Upon the rogue reader receiving the backscattered signal, the only thing that it can do is send back some guess as to what the other portion of the key, N is. This is shown in step 1144 as “N_{guess}”. In other words, because the reader does not have access to the back-end database, it cannot determine what N is, and will have to send a guessed value of N, i.e. N_{guess}, optionally encrypted by some function of R_{1-time pad} back to the tag. Because, for all practical purposes, the reader cannot guess the true value of N, the tag will not authenticate the reader and will not divulge any further information to the rogue reader. It should be mentioned that if the tag is password protected, as described above, the rogue reader will not even receive any response during polling.

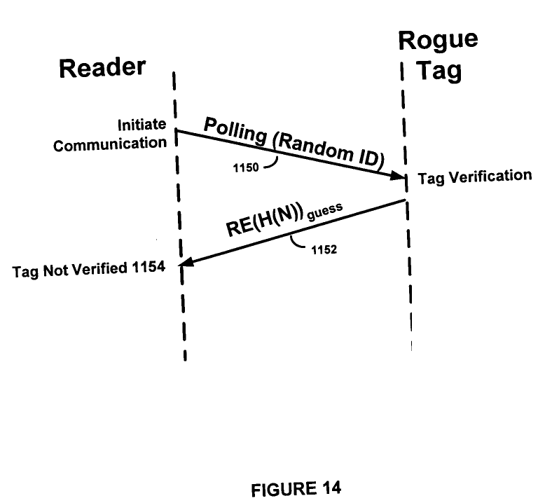

FIG. 14 shows how, in establishing a secure two-way communication link according to embodiments of the present invention, a rogue tag is prevented from communicating with a legitimate reader. This security measure is important since it prevents a rogue tag from not only communicating with a legitimate reader but also from attempting to gain access to information (e.g. other portion of key, N) stored on the back-end database through the reader. FIG. 14 shows, at step 1150, a reader initiating communication with a rogue tag by a polling signal having a random ID. Because the rogue tag has no information as to the value of a tag partial key, H(N), all that it can do is backscatter a guess, i.e., H(N)_{guess}, at step 1152. Upon receipt of the backscattered signal, the reader consults the back-end database to verify that the tag is authentic. Because it extremely unlikely that the rogue tag properly guessed a true value of H(N), there will be no entry in the database that corresponds to H(N). Accordingly, at step 1154 the reader will establish that the tag is a rogue tag, will not send the rogue tag the value of N, and will not communicate further with the rogue tag.

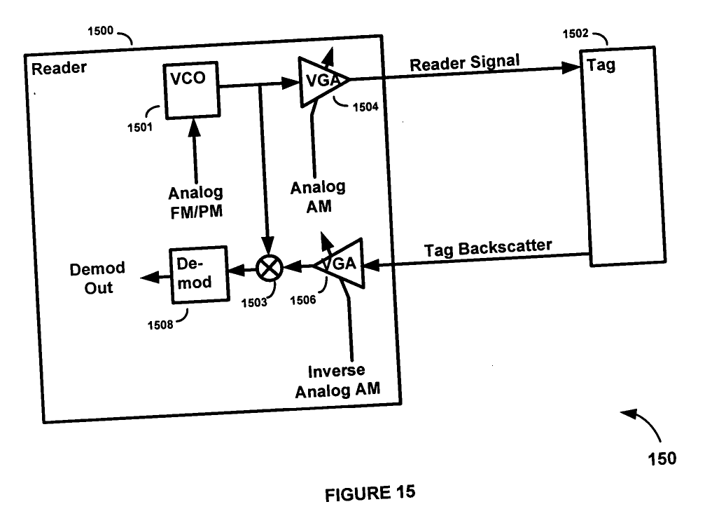

FIG. 15 shows an analog implementation of an RFID system 150, according to an embodiment of the present invention, in which both AM and FM/PM are used to modulate an RF carrier signal. According to this embodiment, a reader 1500 includes a voltage controlled oscillator (VCO) 1501 that generates a carrier signal for broadcasting to a tag 1502. The carrier signal generated by the VCO 1501 is modulated by an analog FM/PM signal. Analog AM is also applied to the carrier by varying the gain of a variable gain amplifier (VGA) 1504. The AM and FM/PM modulated signal is transmitted to the tag 1502, which backscatter modulates the carrier signal with tag information back to the reader 1500. As described in detail above, the AM and FM/PM mask the tag information in a backscatter modulated signal. Upon receipt of the backscattered signal, the inverse of the gain applied to the transmitting VGA is applied to a receiving VGA 1506. The received signal is also mixed with the signal provided at the output of the VCO 1501 by a mixer 1503 to remove the FM/PM. Finally, the signal is sent through a demodulator 1508 to provide a baseband signal containing the tag information backscattered by the tag 1502.

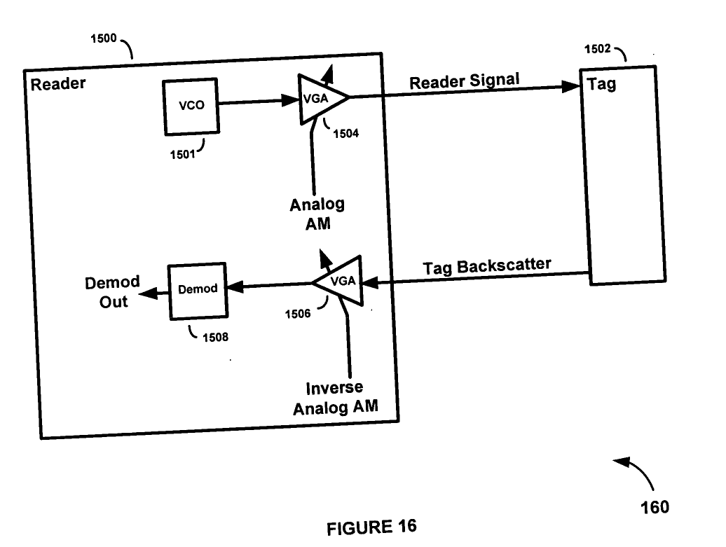

FIG. 16 shows an analog implementation of an RFID system 160, in which AM is used to modulate the carrier signal, according to an embodiment of the present invention. This embodiment is similar to the embodiment shown in FIG. 15, except that no FM/PM is applied to the RF carrier signal.

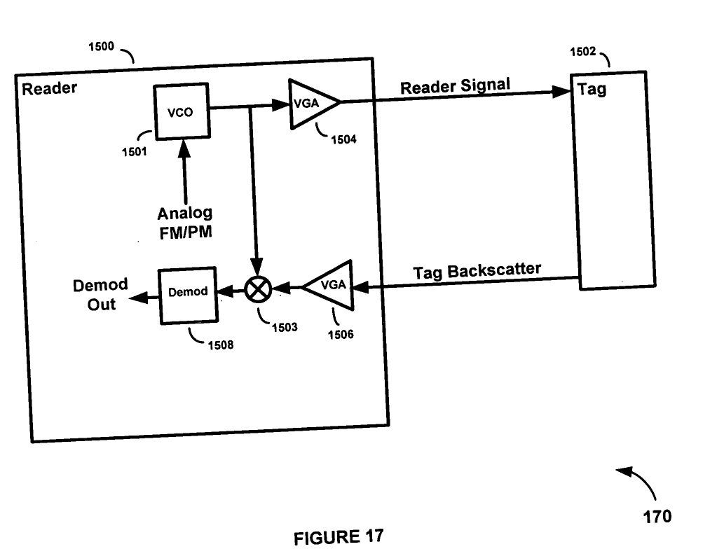

FIG. 17 shows an analog implementation of an RFID system 170, in which FM/PM is used to modulate the carrier signal, according to an embodiment of the present invention. This embodiment is similar to the embodiment shown in FIG. 15, except that no AM is applied to the RF carrier signal.

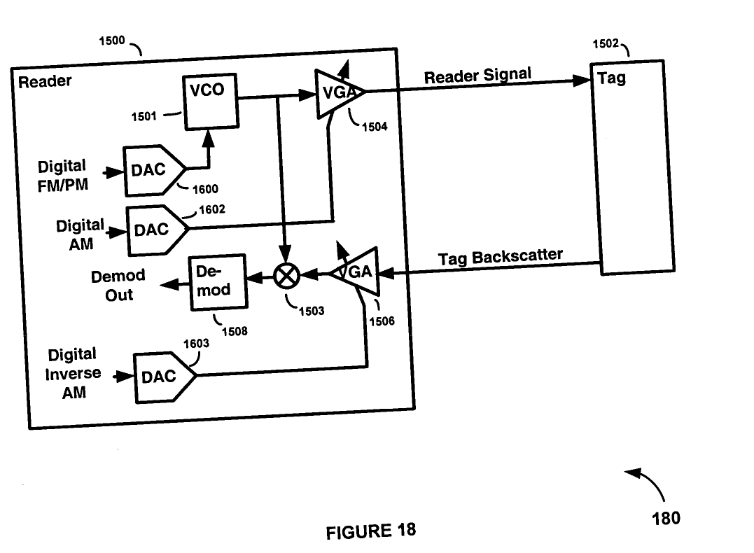

FIG. 18 shows a combined analog and digital implementation of an RFID system 180, in which both AM and FM/PM are used to modulate an RF carrier signal, according to an embodiment of the present invention. This implementation is similar to the implementation shown in FIG. 15, the primary difference being that the source of signals for the AM and FM/PM are digital sources in the embodiment shown in FIG. 18. Accordingly, digital-to-analog converters (DACs) 1600 and 1602 are used to convert the digital FM/PM and digital AM signals into analog signals, respectively, before they are applied to the VCO 1501 and the gain control input of VGA 1504. A DAC 1603 is also used to convert the inverse AM to an analog signal.

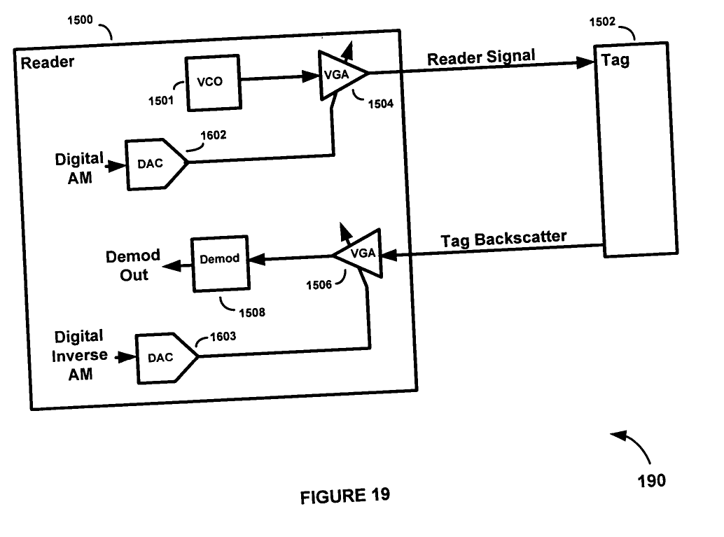

FIG. 19 shows a combined analog and digital implementation of an RFID system 190, in which AM is used to modulate an RF carrier signal, according to an embodiment of the present invention. This embodiment is similar to the embodiment shown in FIG. 16, except that the source of the AM and inverse AM signals are digital. DACs 1602 and 1604 are used to convert the digital AM and digital inverse AM signal into analog signals, respectively, which control the gains of the transmitting VGA 1504 and receiving VGA 1506.

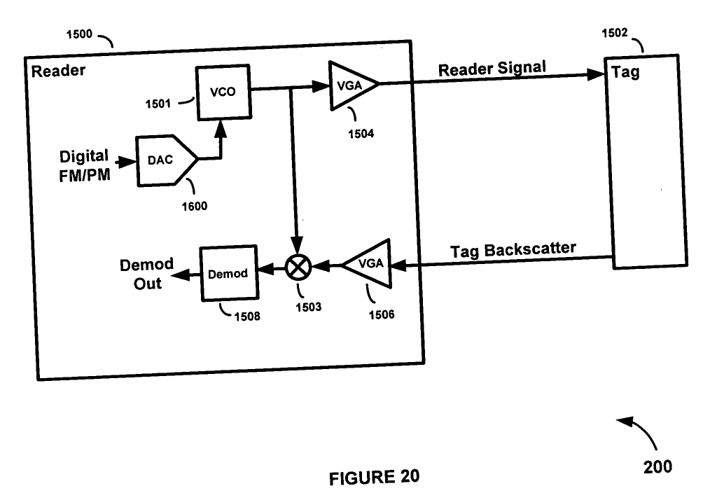

FIG. 20 shows a combined analog and digital implementation of an RFID system 200, in which FM/PM is used to modulate an RF carrier signal, according to an embodiment of the present invention. This embodiment is similar the embodiment shown in FIG. 17, except that the source of the FM/PM is digital. DAC 1600 is used to convert the digital FM/PM signal into an analog signal, which is used to modulate the VCO 1501.

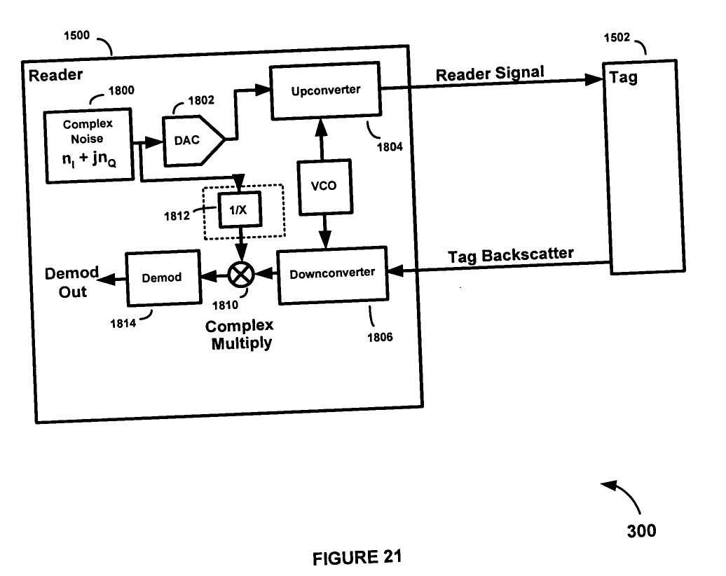

FIG. 21 shows a digital implementation of an RFID system 300, according to an embodiment of the present invention. According to this embodiment, a complex noise source 1800 is converted to an analog signal by a DAC 1802. The output of the DAC 1802 is coupled to an upconverter 1804, which provides an RF carrier that is transmitted to the tag 1502. The tag 1502 backscatter modulates the carrier signal with tag information back to the reader 1500. A downconverter 1806 is configured to receive the backscatter modulated signal, which it downconverts. A complex multiplier 1810 multiplies the downconverted signal with the inverse of the complex noise signal generated by the complex noise source 1800. Alternatively, the multiplier may be an analog multiplier, in which case an inverse function 1812 is used to invert the complex noise signal, which is then applied to a DAC prior to multiplying it with the downconverted signal. Finally, a demodulator 1814 demodulates the multiplied signal to provide a baseband signal containing the tag information backscattered by the tag 1502.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope all such changes and modifications as are within the true spirit and scope of this invention.

1. In an RFID system, a method of communicating securely between a reader and a tag, comprising:
at the reader, modulating an RF carrier signal with a noise encryption signal to produce a noise-encrypted RF carrier signal;
transmitting the noise-encrypted RF carrier signal to the tag; and
at the tag, backscatter modulating the noise-encrypted RF carrier signal with a tag information signal to produce a noise-encrypted backscattered signal.

2. The method of claim 1, further comprising:
at the reader,
receiving the backscatter modulated noise-encrypted signal;
removing the noise encryption; and
recovering the tag information signal.

3. The method of claim 1 wherein modulating the RF carrier signal with a noise encryption signal comprises amplitude modulating the RF carrier signal.

4. The method of claim 1 wherein modulating the RF carrier signal with a noise encryption signal comprises phase modulating or frequency modulating the RF carrier signal.

5. The method of claim 3 wherein modulating the RF carrier signal with a noise encryption signal further comprises phase modulating or frequency modulating the RF carrier signal.

6. The method of claim 1 wherein the tag information comprises a tag identification number.

7. The method of claim 1 wherein the tag information comprises information associated with an item to which the tag is attached.

8. An RFID system, comprising:
a reader operable to modulate an RF carrier signal with a noise encryption waveform and broadcast the resulting noise-encrypted RF carrier signal to a population of tags; and
at least one of the tags of the population of tags configured to receive the noise-encrypted RF carrier signal and backscatter modulate the received noise-encrypted RF carrier signal with a tag information signal.

9. The RFID system of claim 8 wherein the reader is further operable to receive the backscatter modulated noise-encrypted signal, remove the noise encryption, and recover the tag information signal.

10. The RFID system of claim 8 wherein the noise encryption waveform includes an amplitude modulation component.

11. The RFID system of claim 8 wherein the noise encryption waveform includes a phase or frequency modulation component.

12. The RFID system of claim 11 wherein the noise encryption waveform further includes an amplitude modulation component.

13. The RFID system of claim 9 wherein the noise encryption waveform includes an amplitude modulation component.

14. The RFID system of claim 9 wherein the noise encryption waveform includes a phase or frequency modulation component.

15. The RFID system of claim 14 wherein the noise encryption waveform further includes an amplitude modulation component.

16. A method of preventing an eavesdropper from intercepting a backscattered signal from a tag in an RFID system, comprising:
applying amplitude modulation to a carrier signal generated by a reader;
broadcasting the modulated carrier signal to a tag of the RFID system;
backscatter modulating the modulated carrier signal with tag information.

17. The RFID system of claim 16, further comprising:
at the reader,
receiving the backscatter modulated signal;
removing the amplitude modulation; and
recovering the tag information.

18. A method of preventing an eavesdropper from intercepting a backscattered signal from a tag in an RFID system, comprising:
applying phase or frequency modulation to a carrier signal generated by a reader;
broadcasting the modulated carrier signal to a tag of the RFID system; and
backscatter modulating the modulated carrier signal with tag information.

19. The method of claim 18, further comprising:
at the reader,
receiving the backscatter modulated signal;
removing the phase or frequency modulation; and
recovering the tag information.

20. The method of claim 18, further comprising applying amplitude modulation to the carrier signal, before broadcasting the modulated carrier signal to the tag.

21. The method of claim 20, further comprising:
at the reader,
receiving the backscatter modulated signal;
removing the amplitude modulation and phase or frequency modulation;
and
recovering the tag information.

22. A method of forming an RFID system, comprising:
providing a reader designed to modulate a carrier signal with a noise encryption signal to produce a noise-encrypted carrier signal; and
providing one or more tags designed to receive a broadcast of the noise-encrypted carrier signal and backscatter modulate a reverse link encrypted signal modulated by tag information.

23. The method of claim 22 wherein the reader is further designed to:
receive the reverse link encrypted signal;
remove the noise encryption; and
recover the tag information.

24. The method of claim 22 wherein the noise encryption signal comprises an amplitude modulation signal.

25. The method of claim 22 wherein the noise encryption signal comprises a phase or frequency modulation signal.

26. The method of claim 25 wherein the encryption signal further comprises an amplitude modulation signal.

27. An RFID system, comprising:
a reader having:
a voltage controlled oscillator (VCO) operable to produce a carrier signal;
a variable gain amplifier (VGA) having a first input configured to receive the carrier signal from the VCO and a second gain control input configured to receive an amplitude modulation signal, said VGA operable to generate an amplitude modulated carrier signal; and
one or more tags configured to receive and backscatter modulate the amplitude modulated carrier signal with tag information stored on the one or more tags,
wherein said amplitude modulation signal operates to noise encrypt the backscatter modulated signal.

28. The RFID system of claim 27 wherein the VCO includes a phase or frequency control input configured to receive a phase or frequency modulation signal.

29. An RFID system, comprising:
a reader having a voltage controlled oscillator (VCO) configured to receive a phase or frequency modulation signal and provide a phase or frequency modulated carrier signal; and
one or more tags configured to receive and backscatter modulate the phase or frequency modulated carrier signal with tag information stored on the one or more tags,
wherein said phase or frequency modulation signal operates to noise encrypt the backscatter modulated signal.

30. The RFID system of claim 29 wherein the reader further comprises a variable gain amplifier (VGA) having a first input configured to receive the phase or frequency modulated carrier signal from the VCO and a second gain control input configured to receive an amplitude modulation signal to amplitude modulate the phase or frequency modulated carrier signal, and wherein said amplitude modulation signal operates to further noise encrypt the backscatter modulated signal.

31. A method of establishing a secure two-way communication link between a reader and a tag in an RFID system, comprising:
singulating a tag from a population of tags;
at the reader, modulating a carrier signal with a noise encryption signal;
at the singulated tag, backscatter modulating the noise-encrypted signal with a first portion of a key;
at the reader, verifying that the singulated tag is an authentic tag; and
at the reader, transmitting a second portion of said key to the singulated tag.

32. The method of claim 31 wherein singulating a tag from a population of tags comprises using information stored on the tag to be singulated, or using a random number generated by the tag to be singulated, in order to prevent exposing tag information prior to completing the establishment of the secure two-way communication link.

33. The method of claim 32 wherein said information is non-identifying information.

34. The method of claim 31 wherein the noise encryption signal comprises an amplitude modulation signal.

35. The method of claim 31 wherein the noise encryption signal comprises a frequency or phase modulation signal.

36. The method of claim 35 wherein the noise encryption signal further comprises an amplitude modulation signal.

37. The method of claim 31, further comprising:
at the reader, modifying the value of a portion of the key; and
at the singulated tag, updating the value of the portion of the key according to the modification.

38. The method of claim 31, further comprising transmitting a password and a lock command from the reader to the singulated tag, so that the singulated tag no longer responds to a reader unless the password is first received by the singulated tag.

39. The method of claim 31, further comprising transmitting a password and a lock command from the reader to the singulated tag, so that the singulated tag responds to a reader but reveals no information stored on the singulated tag unless the password is first received by the tag.

40. A method of establishing a secure two-way communication link between a reader and a tag in an RFID system, comprising:
singulating a tag from a population of tags;
at the reader, modulating a carrier signal with a noise encryption signal; and
at the singulated tag, backscatter modulating the noise-encrypted signal with a one-time pad.

41. The method of claim 40 wherein the one-time pad is generated by the tag.

42. The method of claim 40 wherein the one-time pad is stored on the tag.

43. The method of claim 40 wherein reader-to-tag communications are encrypted with a function of the one-time pad.

44. The method of claim 40, further comprising modifying the one-time pad after use.

45. The method of claim 44 wherein the singulated tag performs the modifying of the one-time pad.

46. The method of claim 44 wherein the reader requests the modifying of the one-time pad.

47. The method of claim 44, further comprising:
at the tag, backscatter modulating one or more modified one-time pads; and
at the reader, using said one or more modified one-time pads to secure ongoing communications with the singulated tag.

48. The method of claim 43, further comprising:
at the singulated tag,
removing the encryption generated by the function of the one-time pad.

49. The method of claim 40 wherein the noise encryption signal comprises an amplitude modulation signal.

50. The method of claim 40 wherein the noise encryption signal comprises a frequency or phase modulation signal.

51. The method of claim 50 wherein the noise encryption signal further comprises an amplitude modulation signal.

52. The method of claim 40, further comprising transmitting a password and a lock command from the reader to the singulated tag, so that the singulated tag no longer responds to a reader unless the password is first received by the singulated tag.

53. The method of claim 40, further comprising transmitting a password and a lock command from the reader to the singulated tag, so that the singulated tag responds to a reader but reveals no information stored on the singulated tag unless the password is first received by the tag.

54. A method of establishing a secure two-way communication link between a reader and a tag in an RFID system, comprising:
singulating a tag from a population of tags;
at the reader, modulating a carrier signal with a noise encryption signal;
at the singulated tag, backscatter modulating the noise encrypted signal with a first portion of a key and a one-time pad;
at the reader, verifying that the singulated tag is an authentic tag; and
at the reader, transmitting a second portion of said key to the singulated tag.

55. The method of claim 54 wherein the second portion of said key is encrypted with a function dependent upon the one-time pad before it transmitted to the singulated key.

56. The method of claim 54 wherein singulating a tag from a population of tags comprises using information stored on the tag to be singulated, or using a random number generated by the tag to be singulated, in order to prevent exposing tag information prior to completing the establishment of the secure two-way communication link.

57. The method of claim 56 wherein said information is non-identifying information.

58. The method of claim 54 wherein the one-time pad is generated by the tag.

59. The method of claim 54 wherein the one-time pad is stored on the tag.

60. The method of claim 43 wherein reader-to-tag communications are encrypted with a function of the one-time pad.

61. The method of claim 54, further comprising modifying the one-time pad after use.

62. The method of claim 61 wherein the singulated tag performs the modifying of the one-time pad.

63. The method of claim 61 wherein the reader requests the modifying of the one-time pad.

64. The method of claim 61, further comprising:
at the tag, backscatter modulating one or more modified one-time pads; and
at the reader, using said one or more modified one-time pads to secure ongoing communications with the singulated tag.

65. The method of claim 60, further comprising:
at the singulated tag,
removing the encryption generated by the function of the one-time pad.

66. The method of claim 54 wherein the noise encryption signal comprises an amplitude modulation signal.

67. The method of claim 54 wherein the noise encryption signal comprises a frequency or phase modulation signal.

68. The method of claim 67 wherein the noise encryption signal further comprises an amplitude modulation signal.

69. The method of claim 54, further comprising:
at the reader, modifying the value of a portion of the key; and
at the singulated tag, updating the value of the portion of the key according to the modification.

70. The method of claim 54, further comprising transmitting a password and a lock command from the reader to the singulated tag, so that the singulated tag no longer responds to a reader unless the password is first received by the singulated tag.

71. The method of claim 54, further comprising transmitting a password and a lock command from the reader to the singulated tag, so that the singulated tag responds to a reader but reveals no information stored on the singulated tag unless the password is first received by the tag.

72. A reader for an RFID system, comprising:
a noise encryption signal generator; and
a modulator operable to noise encrypt a carrier signal,
wherein said reader is operable to transmit a noise-encrypted RF carrier signal to one or more tags and receive a noise-encrypted backscatter signal modulated by tag information, when the reader is configured in the RFID system.

73. The reader of claim 72 wherein the noise encryption signal generator includes apparatus configured to generate an amplitude modulation signal.

74. The reader of claim 72 wherein the noise encryption signal generator includes apparatus configured to generate a phase modulation or frequency modulation signal.

75. The reader of claim 74 wherein the noise encryption signal generator further includes apparatus configured to generate an amplitude modulation signal.

76. The reader of claim 72 wherein the reader further includes apparatus configured to remove the noise encryption from the received noise-encrypted backscatter signal and recover the tag information.

77. A reader for an RFID system, comprising:
means for noise encrypting an RF carrier signal broadcast to a tag;
means for receiving a noise-encrypted backscatter modulated signal from the tag;
means for removing the noise encryption from the received noise-encrypted backscatter modulated signal; and
means for recovering tag information sent in the noise-encrypted backscatter modulated signal.

78. The reader of claim 77 wherein said means for noise encrypting an RF carrier signal comprises means for generating an amplitude modulation signal.

79. The reader of claim 77 wherein said means for noise encrypting an RF carrier signal comprises means for generating a phase modulation or frequency modulation signal.

80. The reader of claim 79 wherein said means for noise encrypting an RF carrier signal further comprises means for generating an amplitude modulation signal.
